(19) United States
(12) Patent Application Publication
(10) Pub. No.: US 2007/0228613 A1
(43) Pub. Date: Oct. 4, 2007

(54) SYSTEM FOR FILLING MOLDS WITH CEMENTITIOUS CONCRETE-LIKE MATERIAL AND FOR UNMOLDING RESULTING PRODUCTS

(75) Inventors: Jean-Francois Plourde, Granby (CA); Dave Cyr, Marieville (CA); Andy Levesque, St-Pie (CA); Dominic Paris, St-Alphonse-de-Granby (CA); Alexandre Bernier, St-Valerien (CA); Mario Bernier, Granby (CA); Andre Roy, St-Alphonse-de-Granby (CA)

Correspondence Address: AKERMAN SENTERFITT, P.O. BOX 3188, WEST PALM BEACH, FL, 33402-3188, US

(73) Assignee: GROUPE GRB INC., Saint-Alphonse de Granby (CA)

(21) Appl. No.: 11/551,619

(22) Filed: Oct. 20, 2006

Related U.S. Application Data
(60) Provisional application No. 60/728,474, filed on Oct. 20, 2005.

(51) Int. Cl. B29C 69/02

(52) U.S. Cl. 264/349; 425/317; 425/436 RM; 425/437; 425/447; 425/472

(57) ABSTRACT

A system for filling molds with cementitious concrete-like material and for unmolding resulting products, the system is comprised of an unmolding and molding subsystem. This subsystem is comprised of a mold unstacking station, an unmolding station, a mold pre-processing station, a concrete pouring station, a concrete leveling station and a mold stacking station. The system is also comprised of a concrete curing station and a concrete batching station.

### CROSS REFERENCE TO RELATED APPLICATIONS

This application claims priority on U.S. Provisional Application Ser. No. 60/728,474 filed on Oct. 20, 2005. All documents above are herein incorporated by reference.

### FIELD OF THE INVENTION

The present invention relates to a system for making molded products and more specifically to an automated system for filling molds with cementitious concrete-like material and for unmolding resulting products.

### BACKGROUND OF THE INVENTION

Molded products manufactured of cementitious concrete-like materials are commonly used in various applications for the fabrication of various structural and/or aesthetic constructions. These products are generally fabricated by molding cement and/or concrete mixtures in various shapes and configurations and, once settled and dried, assembled or configured by a mason or other such stoneworker.

However, current systems and apparatus for making these molded products generally require significant manpower to implement the various molding, unmolding and curing processes involved in the preparation of such products.

### SUMMARY OF THE INVENTION

In order to address the above and other drawbacks of the prior art, it is an aim of the present invention to provide a system for making molded products.

It is also an aim of the present invention to provide a number of automated stations for use in the above system.

More specifically, in accordance with the present invention, there is provided a system for producing cementitious products, said system comprising: at least one mold for receiving cementitious material therein; a molding and an unmolding subsystem comprising: a pouring station for pouring the cementitious material into said mold; and a demolding station for removing formed cementitious products after curing thereof from said mold; and a movement imparting system for imparting a translational movement between said mold and said molding and an unmolding subsystem.

A demolding station for dislodging and removing molded cementitious products from a mold, said demolding station comprising a dislodging system, said mold comprising a bottom plate portion and top resilient portion containing the molded cementitious products, said bottom plate portion comprising openings, said dislodging system comprising moveable protrusions for engaging said top resilient portion through said bottom portion openings thereby dislodging said cementitious products.

A pouring station for pouring cementitious material into a mold for molding a cementitious product, said mold comprising at least one mold compartment, said station comprising: a cementitious material pouring device, a movement imparting device for imparting a translational movement between said pouring device and said mold, and a locating device for stopping said mold during translational movement thereof at least one predetermined position, said predetermined position corresponding to a predetermined position of said at least one mold compartment near said pouring device so as to receive cementitious material therefrom; wherein when said locating device stops said mold at said predetermined position said pouring device pours cementitious material in said predeterminedly positioned mold compartment.

A curing station for curing cementitious material within molds, said station comprising support structure defining a curing chamber, said support structure defining a mold entry end and an opposite mold exit end and having a downward inclination from said entry end to said exit end for providing for said molds in said curing chamber to be displaced via gravity pull from said entry end to said exit end, wherein said period of time for displacing said molds from said entry end to said displacement end is sufficient for curing the cementitious material within said molds.

A batching station for preparing molding mixtures of cementitious material, said station comprising: concrete mixing station; weighing and storage bins for aggregates; aggregate-weighing handling and control equipment positioned beneath said bins and in communication with said concrete mixing station; aggregate handling equipment in communication with said aggregate-weighing handling and control equipment; adjuvant dosing and injecting system in communication with said concrete mixing station; cement storage silo; cement handling equipment in communication with said cement storage silo; and concrete weighing and accumulating bin in communication with said cement handling equipment and said concrete mixing station

A system for producing cementitious products, said system comprising a controller linked to a molding and an unmolding subsystem; and a batching station for receiving data therefrom and signaling data thereto.

A method for producing cementitious products, said method comprising: providing a plurality molds; displacing said plurality of molds on a continuous pathway during said method; successively pouring cementitious material into said molds; continuously batching a mixture of cementitious material mixture that is to be poured; leveling said poured cementitious material within said molds; stacking said molds with said leveled cementitious material; providing a curing chamber for allowing displacement of said stacks of mold therein from an entry end to an exit end thereof for a sufficient curing time to provide formed cementitious products; unstacking said stacked molds having said formed cementitious products; dislodging said formed cementitious products from said molds; removing said formed cementitious products from said molds; stacking said cementitious products; and treating said emptied molds so as to render said molds in condition to receive cementitious material.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a flow chart showing a schematic representation of the system for producing cementitious products of the invention in accordance with an embodiment thereof;

FIG. 2 is a schematic illustration of the system for producing cementitious products of the invention in accordance with an embodiment thereof;

FIG. 3 is a perspective view of a mold having cementitious products in accordance with an embodiment of the invention;

FIG. 4 is an exploded view of FIG. 3;

FIG. 5 is a perspective view of the unstacking station of the present system in accordance with an embodiment of the invention;

FIG. 6 is a perspective view of the demolding station of the present system in accordance with an embodiment of the invention;

FIG. 7 is a partial perspective view of the dislodging system of the demolding station in accordance with an embodiment of the invention;

FIG. 8 is a perspective view of the dislodging system of the demolding station in accordance with an embodiment of the invention;

FIGS. 9 and 10 are perspective views of the stacking system of the demolding station in accordance with an embodiment of the invention;

FIG. 11 is a front elevation view of the stacking system of the demolding station in accordance with an embodiment of the invention;

FIG. 12 is a perspective view of the preprocessing station of the present system in accordance with an embodiment of the invention;

FIG. 13 is a front perspective view of the pouring station of the present system in accordance with an embodiment of the invention;

FIG. 14 is a partial front perspective view of the pouring station of the present system in accordance with an embodiment of the invention;

FIG. 15 is a view similar to FIG. 13 without the vats of the pouring station;

FIG. 16 is a back perspective view of the pouring station of FIG. 13.

FIG. 17 is a schematic representation of a vat of the pouring station in accordance with an embodiment of the invention;

FIG. 18 is a perspective view of the lower portion of the vat of FIG. 17;

FIG. 19 is a perspective view of the leveling station of the present system in accordance with an embodiment of the invention;

FIG. 20 is a perspective view of the stacking station of the present system in accordance with an embodiment of the invention;

FIG. 21 is a front perspective lateral view of the curing station of the present system in accordance with an embodiment of the invention;

FIG. 22 is an enlarged partial view of portion “Detail I” of FIG. 21;

FIG. 23 is a front elevation view of the curing station of FIG. 21;

FIG. 24 is a schematic view of the system for controlling and maintaining humidity of curing station in accordance with an embodiment of the invention;

FIG. 25 is a schematic representation of the bathing station of the present system in accordance with an embodiment of the invention;

FIG. 26 is an enlarged view of the portion “Section I” of FIG. 25;

FIG. 27 is an enlarged view of the portion “Detail I” of FIG. 26;

FIG. 28 is an enlarged partial view of the portion “Detail II” of FIG. 26;

FIG. 29 is an enlarged partial view of the portion “Detail III” of FIG. 26;

FIG. 30 is top plan view of FIG. 29;

FIG. 31 is an enlarged view of the portion “Section II” of FIG. 25;

FIG. 32 is an enlarged partial view of the portion “Detail IV” of FIG. 31;

FIG. 33 is a perspective view of a variant unmolding station in accordance with a further embodiment of the invention; and

FIG. 34 is a side view of the unmolding station of FIG. 33.

### DESCRIPTION OF ILLUSTRATIVE EMBODIMENTS

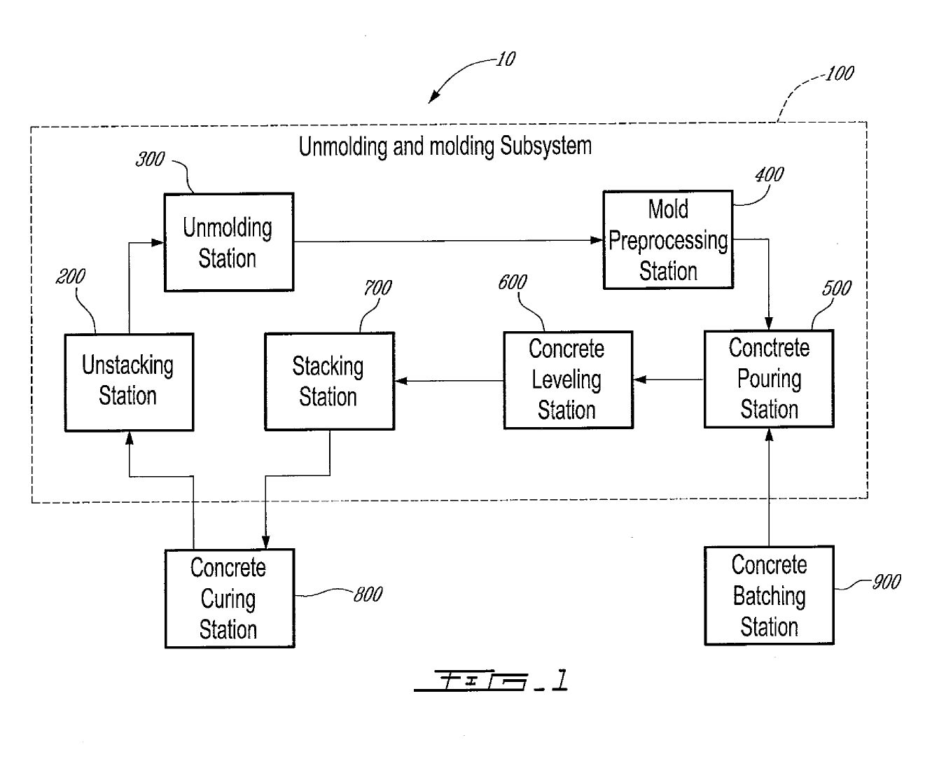

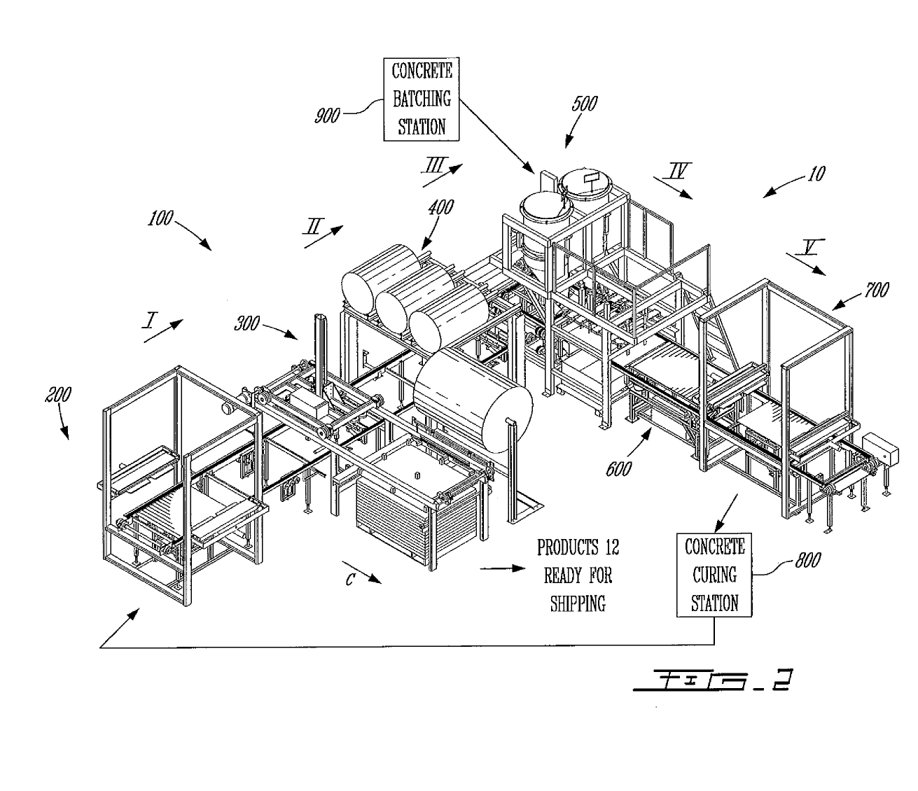

Referring now to FIGS. 1 and 2, in accordance with an illustrative embodiment of the present invention, a system for making molded products, generally referred to using the numeral 10, will now be described. The system 10 is generally comprised of a number of automated subsystems and stations interactively operated to provide a production and processing flow of molded products.

In particular, the system 10 is illustratively comprised of an unmolding and molding subsystem 100, itself comprised of a mold unstacking station 200, an unmolding station 300, a mold preprocessing station 400, a concrete pouring station 500, a concrete leveling station 600 and a mold stacking station 700. The system 10 is also comprised of a concrete curing station 800 and a concrete batching station 900.

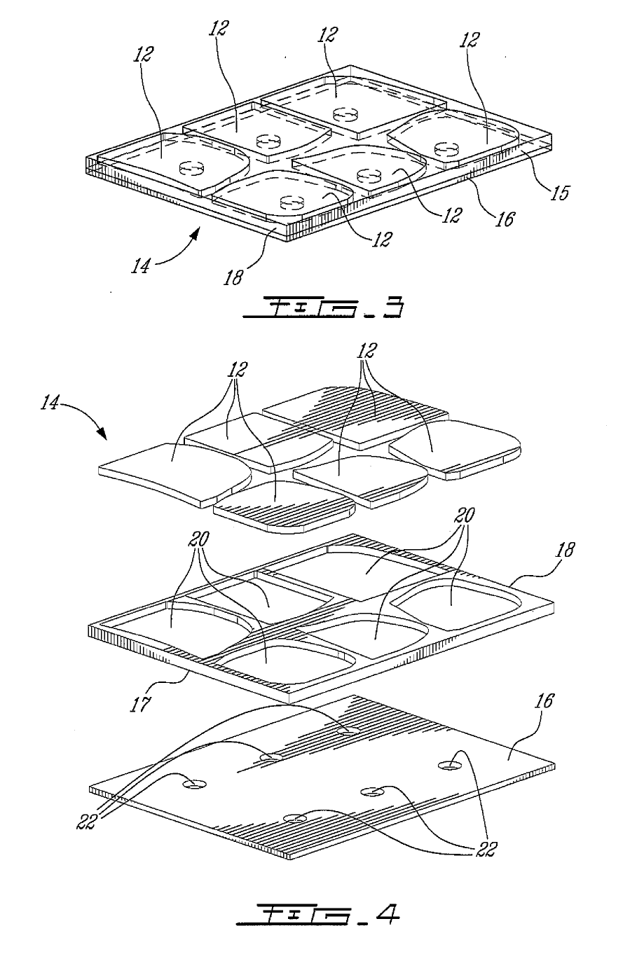

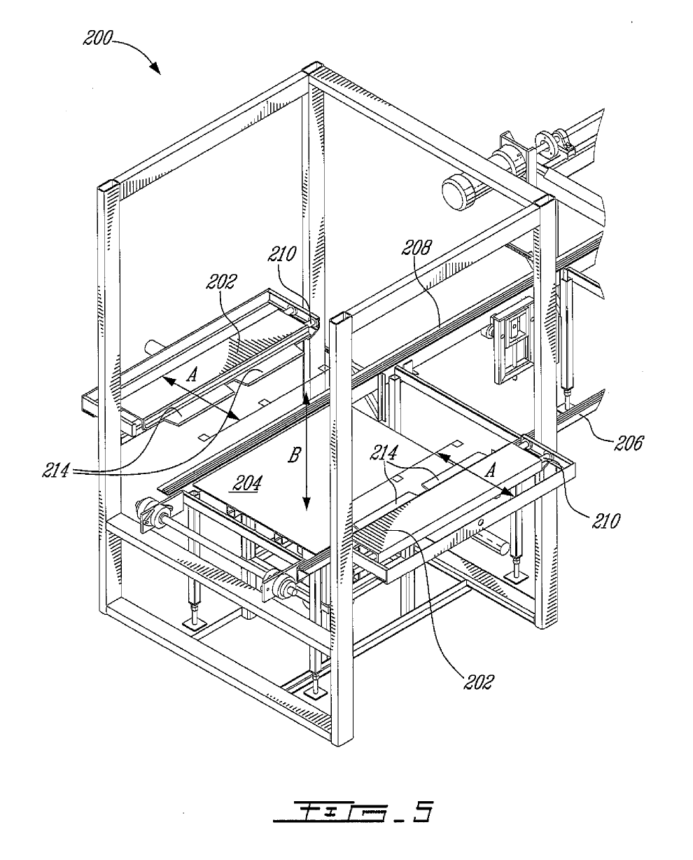

Referring now to FIGS. 3 and 4, the system 10 is generally designed to manufacture various molded cementitious or concrete, and concrete-like products, as in concrete slabs 12, which may include any number of molded slabs, plates, blocks and the like. The molded products 12 are manufactured using a corresponding mold, as in 14, adapted to provide the desired shape and finish to the products 12.

In particular, the mold 14 is comprised of a solid bottom plate or rack 16 and an upper resilient mold 18 defining a number of mold compartments 20 therein for the molding of the products 12. For example, the bottom rack 16 may be manufactured of a solid metal or steel and the inner mold 18 may be manufactured of a resilient rubber of plastic material. Other materials for the manufacture of the rack 16 and inner mold 18 should be apparent to a person of skill in the art. In addition, a number of holes 22, provided through the bottom rack 16, are illustratively positioned below each compartment 20 to facilitate an unmolding of the cured products 12 at the unmolding station 300, as will be described further hereinbelow.

In general and with reference to FIGS. 1 and 2, the system 10 is adapted to cyclically move a mold 14 and its associated molded products 12 through the entire production process. For example, the finished products 12 are brought to the unmolding and molding subsystem 100 in their respective molds 14 where they are successively unstacked at the unstacking station 200 and unmolded at the unmolding station 300. The empty molds 14 are then preprocessed at the mold processing station 400 and filled at the concrete pouring station 500, in order to provide a new set of products 12 which may be first treated at the leveling station 600 and subsequently stacked at the stacking station 700. The newly filled molds are then brought to the curing station 800 where the molding process and final molding products are completed. They are then ready to be brought back to the unmolding and molding subsystem 100 for the next production round.

Concurrently, the concrete batching station 900 mixes and prepares molding mixtures to be transported to the concrete pouring station 500 of the unmolding and molding subsystem 100 such that a continuous flow of products may be produced by the system 10.

Molding and Unmolding Subsystem

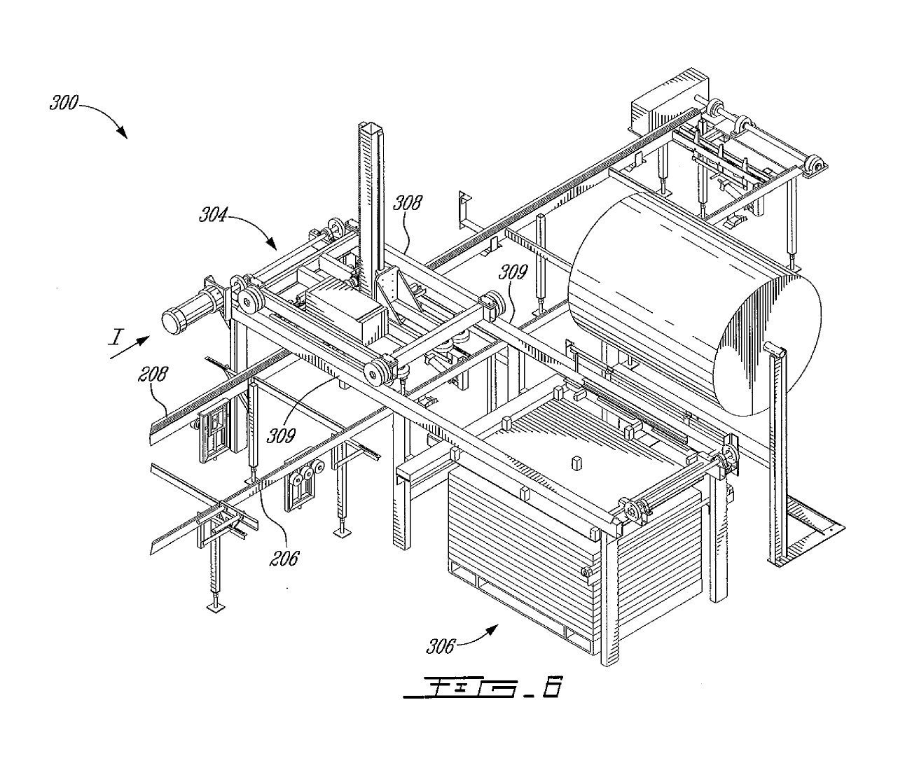

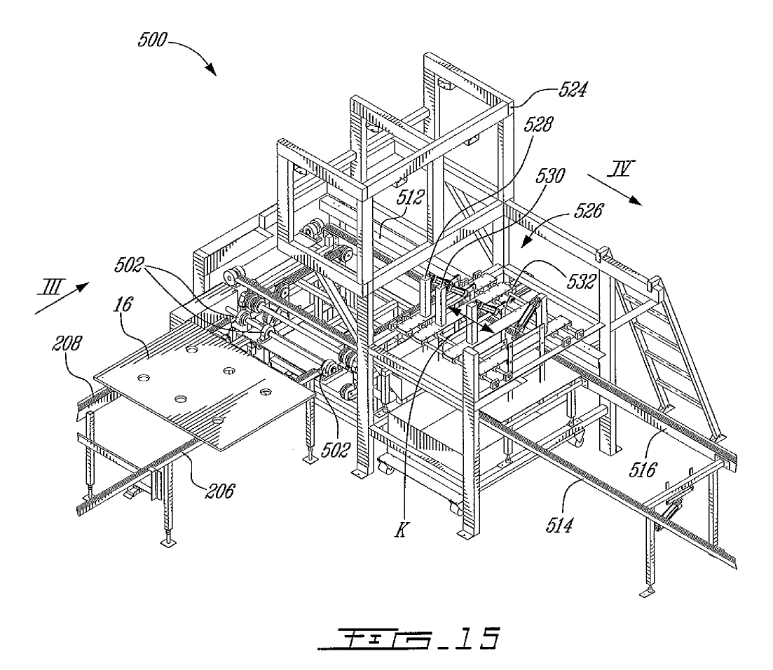

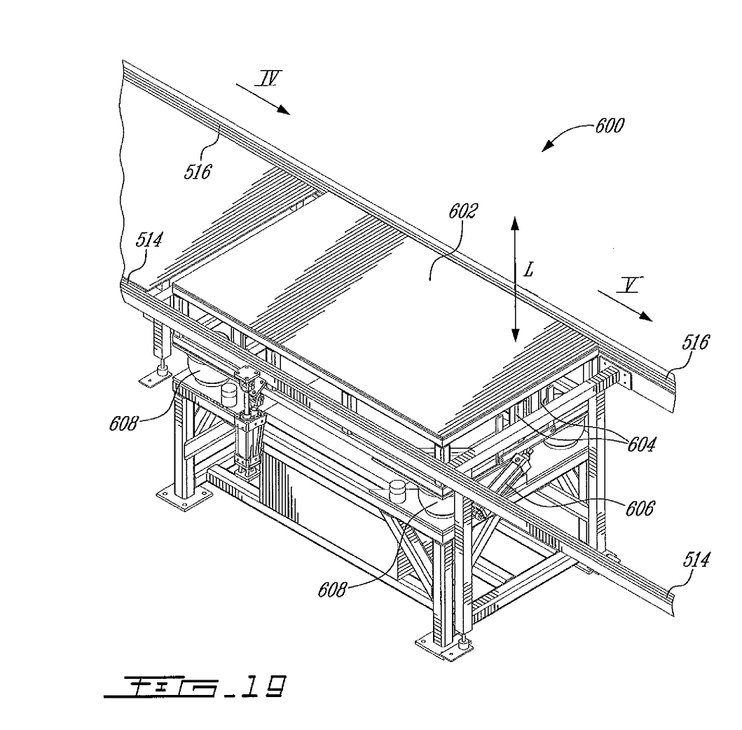

Referring now to FIGS. 1-20, the unmolding and molding subsystem 100 will now be described in greater detail.

As presented hereinabove, the subsystem 100 is first illustratively comprised of a mold unstacking station 200 for receiving stacks or molded finished products 12 and successively feeding individual molds 14 for transport to the unmolding station 300.

With reference to FIG. 2, 5 and 6, the unstacking station 200 is generally comprised of a pair of retractable jaws 202, an elevation platform 204 and two conveyor tracks 206 and 208 for transporting individual molds 14 from the unstacking station 200 to the unmolding station 300. The jaws 202 are adapted to be reciprocally displaced along arrows A, by an actuator 210 such as a hydraulic means or the like, between proximal and distal positions. The elevation platform 204, also activated by an actuator 210 such as hydraulic means or the like, is adapted to reciprocally move vertically along arrow B, between the conveyor tracks 206, 208 and the jaws 202.

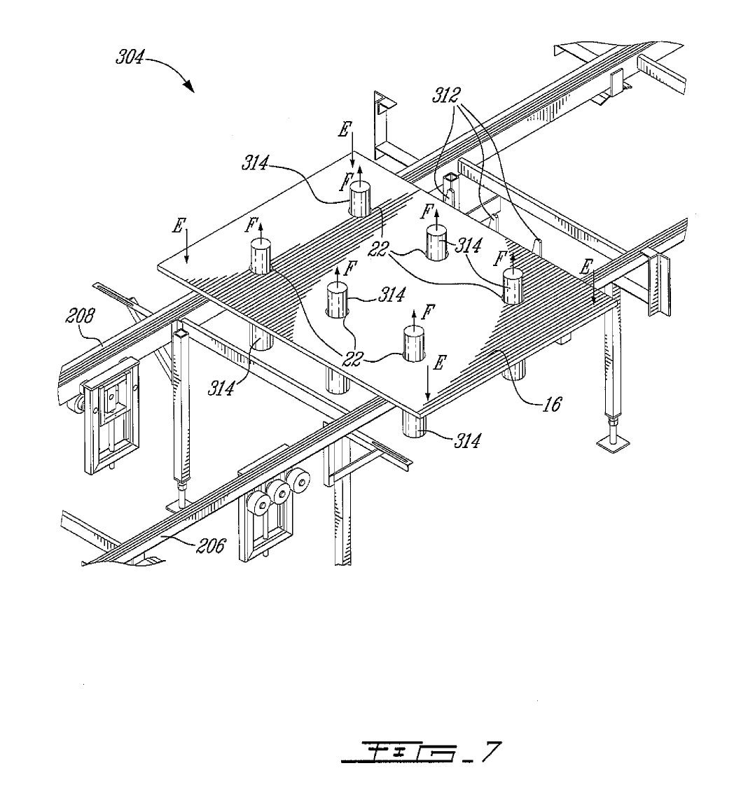

When in the proximal position, the jaws 202 are configured to accept on mold engaging protrusions 214 thereof, a stack of molds in 14 (see FIGS. 3 and 4). This stack may be brought to the unstacking station 200, for example from the curing station 800, by a forklift, conveyor or other such transportation means. To select an individual mold 14 for unmolding, the elevation platform 204 is brought up between the jaws 202 to upwardly engage and lift the bottom of the stack, thereby releasing the jaws 202 of their load. The jaws 202 are retracted to their distal position and the platform 204 is lowered such that a bottommost mold 14 is below a level of the mold engaging protrusions 214. The jaws 202 are then brought back to their proximal position such that protrusions 214 engage the second mold 14 from the bottom of the stack. Consequently, the molds 14 of the stack, other than the bottommost mold 14, are now supported by the jaws 202. As such, the elevation platform 204 may be further lowered to bring the bottommost mold 14 to rest on the conveyer tracks 206, 208 for transport thereof to the unmolding station 300 as shown by arrow I (FIGS. 2 and 6). This process may be repeated for every subsequent mold 14 in the stack until expiry of the stack at which point a new stack may be brought to the unstacking station 200.

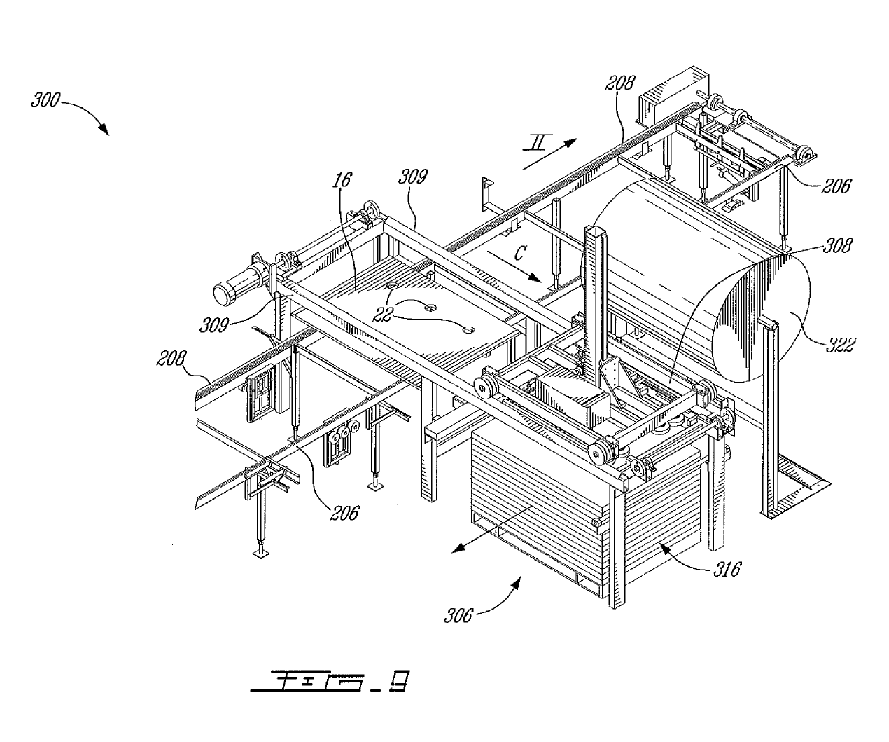

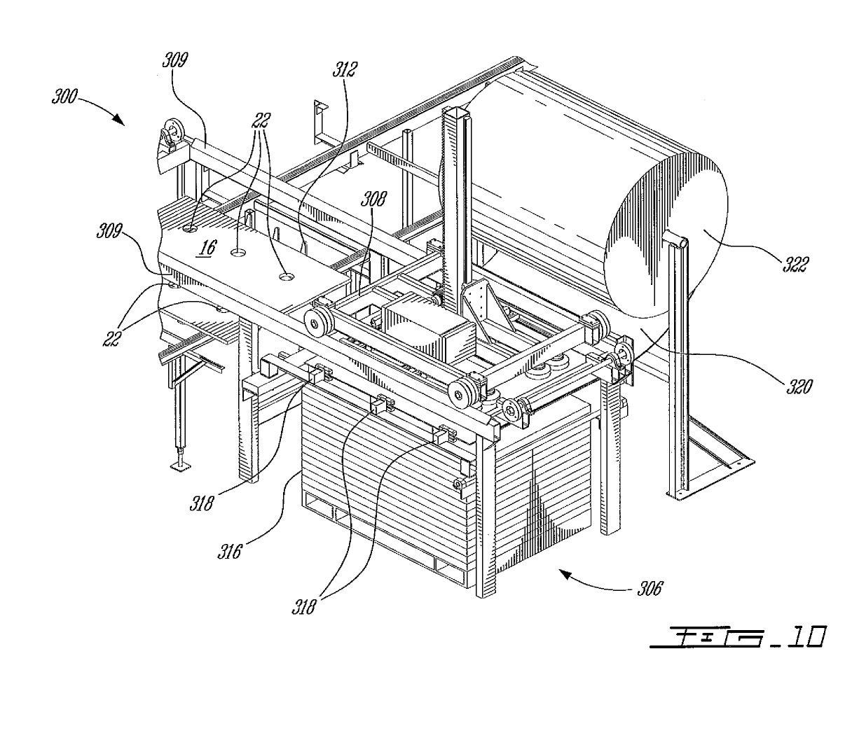

Referring now to FIGS. 2, 6, 7, 8, 9, 10 and 11, the unmolding station 300 will be described in greater detail. In general, the unmolding station 300 is comprised of an unmolding system 304 (FIGS. 6, 7 and 8) for dislodging and extracting the products 12 from their respective mold 14, and a product stacking system 306 (FIGS. 6, 9, 10 and 11) for storing the extracted products 12. A carriage 308, laterally displaceable along arrow C (see FIG. 9) on a set of guide rails 309 to travel between the unmolding system 304 via rollers 305 and the product stacking system 306, is used both to extract and transport the extracted products using a set of suction or vacuum cups 310 (see FIGS. 8, 9 and 10) fitted thereto and vertically displaceable therefrom, along arrow D as shown in FIG. 8, via a pinion gear rack 311.

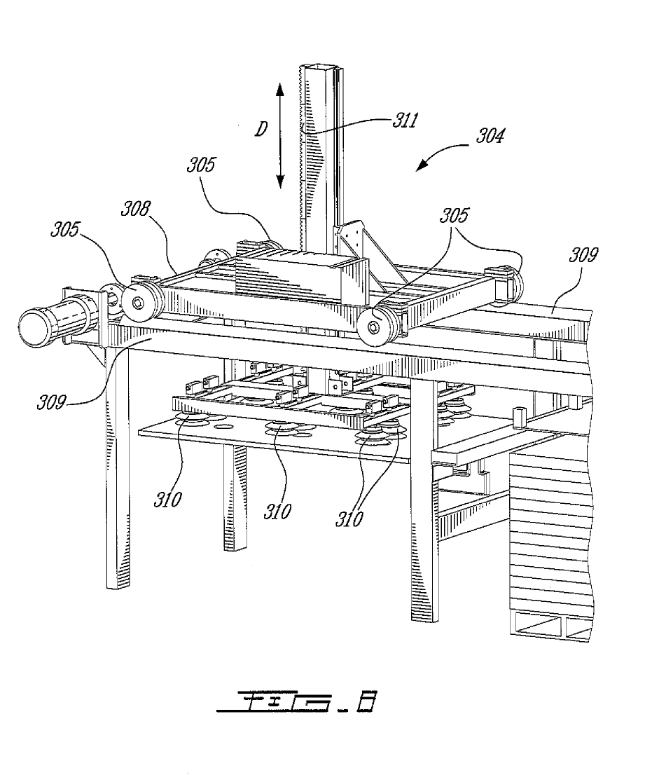

With particular reference to FIGS. 3, 6, 7 and 8, a mold 14 is first transported to the unmolding station 300 by conveyors 206, 208 from the unstacking station 200. A stop 312 (see FIGS. 7 and 10), hydraulically activated between the conveyors 206, 208, is activated to stop and position the mold 14 in line with the unmolding system 304, namely below carriage 308. To initiate a dislodging of the products 12 from the positioned mold 14, a retaining device (not shown) is first lowered from the carriage 308 to apply a downward pressure (arrows E) on a periphery 15 (see FIG. 3) of the mold 14, thereby solidly holding down the mold 14 in position. A set of six hydraulically activated protrusions in the form of push-cylinders 314 are then activated to upwardly project, as shown by arrows F, through the holes 22 of the mold's bottom rack 16 and apply an upward pressure therethrough on a bottom surface 17 of the inner mold 18 (see FIG. 4), namely below each compartment 20 thereof.

Simultaneously and with particular reference to FIG. 8, the vacuum cups 310, lowered to the mold 14 from the carriage 308 and each respectively aligned with a particular product 12, are activated to provide a mild suction on the products to participate in a dislodging thereof. Therefore, the simultaneous action of the retaining device (arrows E) and that of the push cylinders 314 on the resilient inner mold 18 under compartments 20 along with the mild suction on the products 12 fully dislodges these products 12. Once the products 12 are fully dislodged, the cylinders 314 are retracted and the suction stopped allowing the products to settle back in to the mold in proper position. The vacuum cups 310 are then reactivated, this time providing greater suction to the products 12, and retracted vertically toward the carriage 308, thereby extracting the products 12 from the mold 14. As such, the products 12 may be carried by the carriage 308 to the product stacking system 306 in the direction shown by arrow C (FIG. 9). Concurrently, the stop 312 may be deactivated and the empty mold 14 may proceed along conveyors 206, 208 to the mold pre-processing station 400 as shown by arrow 11 (FIGS. 2 and 9).

Referring now to FIGS. 9, 10 and 11, the product stacking system 306 will be described. The carriage 308 is adapted to carry the products 12 and align them above a stack 316 of such products. Simultaneously a displaceable gripping device 318 is adapted to grip and unfold a protective membrane 320 from a membrane roll 322 to cover the uppermost layer of products in stack 316 (FIG. 10). This step is implemented in order to provide a protective membrane 320 between each successive layer of products in the stack.

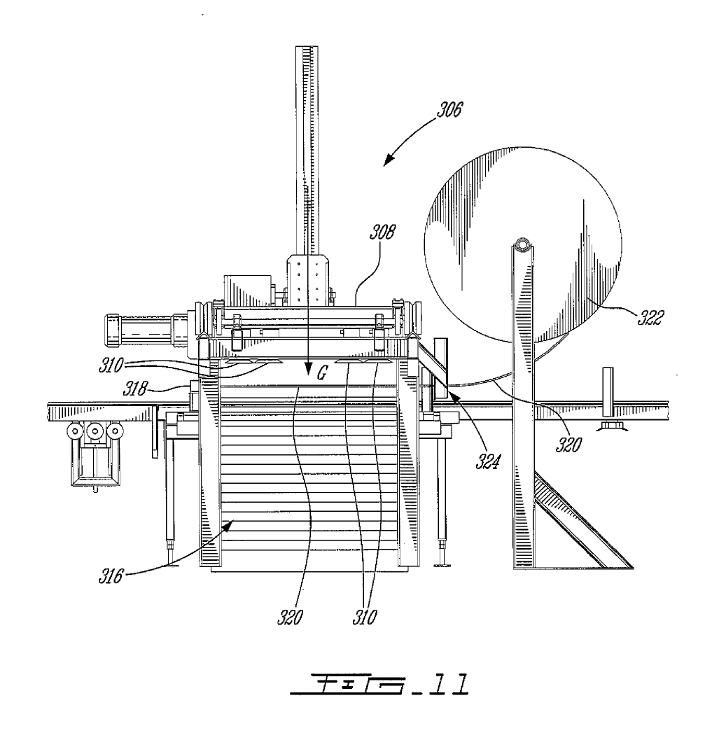

Once the membrane 320 is in place, the extracted products 12, are lowered from the carriage 308, as shown by arrow G (FIG. 11) and positioned on the membrane 320 atop stack 316. A cutter 324 (see FIG. 11) is then used to severe the membrane 320 from the roll 322. The vacuum cups 312 finally release the products 12 and retract toward the carriage 308 to repeat the unmolding process with a subsequent mold 14.

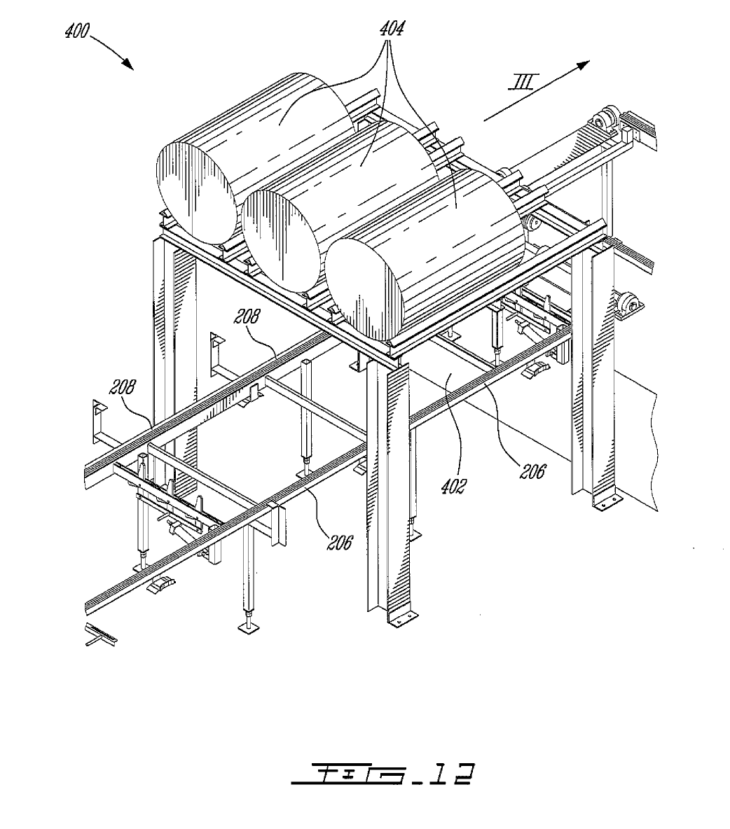

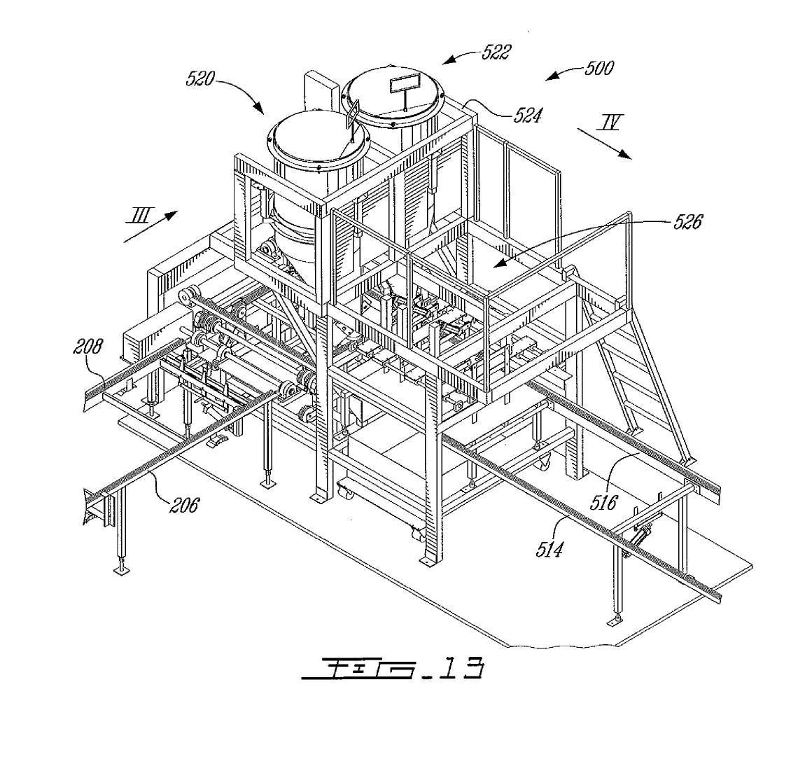

Referring to FIGS. 2, 4 and 12, the mold preprocessing station 400 will be now described. As presented hereinabove, once the product 12 has been extracted from the mold 14, the now empty mold 14 may be transported from the unmolding station 300 by conveyors 206, 208 to the mold pre-processing station 400. In general, the mold preprocessing station 400 is adapted to apply various substances to the empty mold 14, namely within compartments 20, to facilitate demolding of subsequent products 12 therefrom. In the illustrated embodiment, the mold 14 travels along conveyors 206, 208 below a series of jets 402 adapted to spray the mold 14 with various demolding agents, as is known in the art, provided from a series of containers 404 perched above the conveyors 206, 208. As such, the mold is systematically treated by the jets 402 as it progresses through the system 10 to the concrete pouring station 500 as shown by arrow III (see FIGS. 12 and 13).

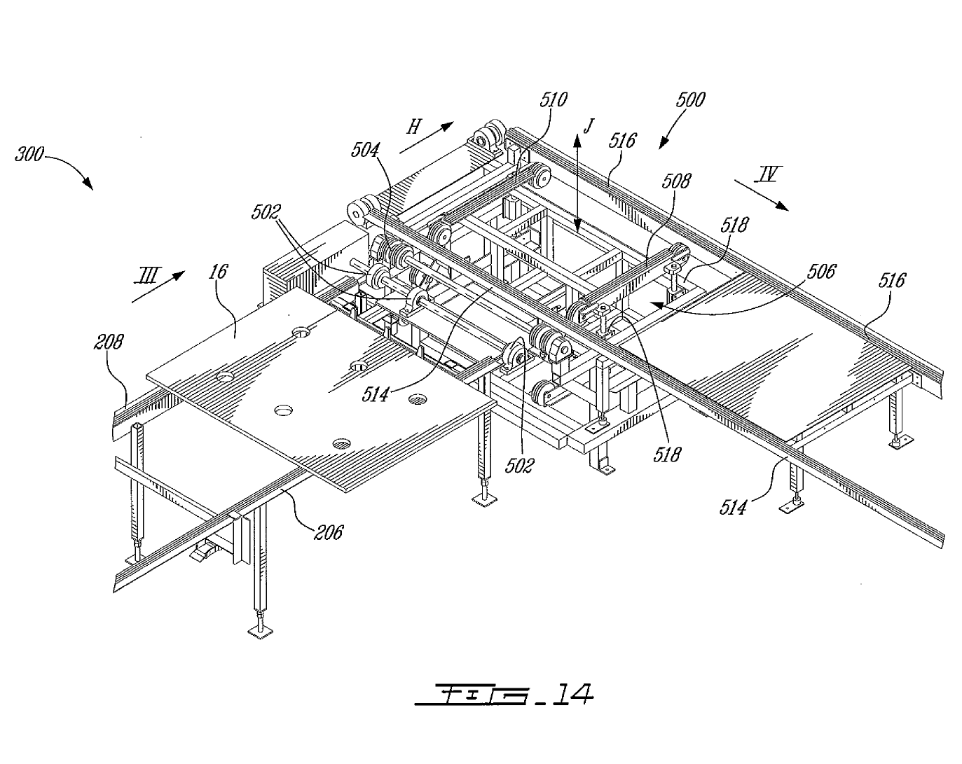

Referring to FIGS. 2, 4, 13, 14, 15, 16, 17 and 18 the concrete pouring station 500 will now described. The emptied and treated mold 14, is displaced along conveyors 206, 208, as shown by arrow III (see FIGS. 2, 12-16). The mold 14 is moved onto ramps 502, which provides access on the entry conveyor 504 for moving the mold onto a bi-directional transfer device 506, Device 506 comprises a pair of conveyor tracks 508 and 510 for moving the mold 14 in the direction shown by arrow H until the mold 14 abuts a stopper 512 (see FIG. 14.) The bidirectional transfer device 506 is positioned above conveyor tracks 514 and 516 and hence, when the mold 14 abuts stopper 512 it is placed directly above tracks 514 and 516. The bidirectional transfer device 506 is reciprocally moveable along a vertical axis J (see FIG. 14) via actuators 518 such as hydraulic means and the like. When the mold 14 abuts stopper 512 it is identified by an electric reader (not shown), once identified the bidirectional transfer device 506 is lowered so as to lay the mold 14 on tracks 514 and 516.

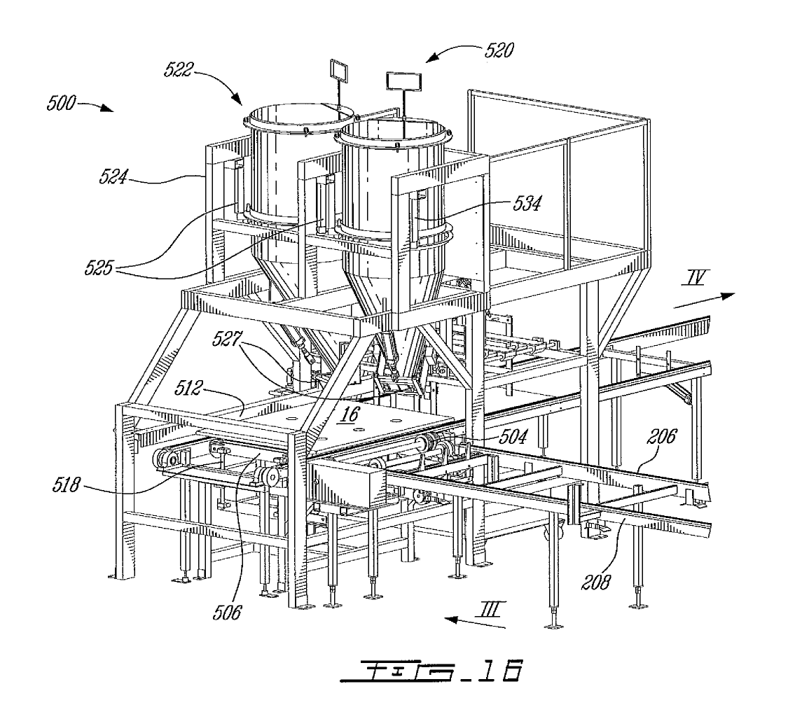

Conveyor tracks 514 and 516 move the mold along the direction shown by arrow IV so as to provide mold 14 to receive concrete within compartments 20. Therefore, the mold 14 is positioned under interchangeable vats 520 and 522, which are fixedly perched above tracks 514 and 516 within a support 524 within respective load cells 525. As the mold 14 is conveyed along tracks 514 and 516 it is so positioned as to place its various compartments 20 directly under the respective nozzles 527 (see FIGS. 16, 17 and 18) of vats 520 and 522 via a locating device 526. Locating device comprises a plurality of adjustable stoppers 528, 530 and 532 (only three stoppers are illustrated in this non-limiting example). The stoppers are adjustable along arrow K, in order to stop the displaced mold 14 at predetermined intervals corresponding to the sequential positioning of compartments 20 directly under nozzles 527 so as to sequentially receive concrete therein. In this example when mold 14 abuts the first stopper 532, a first set of compartments 20 will be filled with concrete, when this operation is complete, the adjustable stopper is retracted so as to allow the mold 14 to be displaced towards the next stopper 530 in order for the subsequent set of compartments 20 to be filled, stopper 530 is retracted and the mold 14 is moved towards the last stopper 532 and the last set of compartments 20 are filled and stopper 532 is retracted allowing the mold 14 to be moved to the next station.

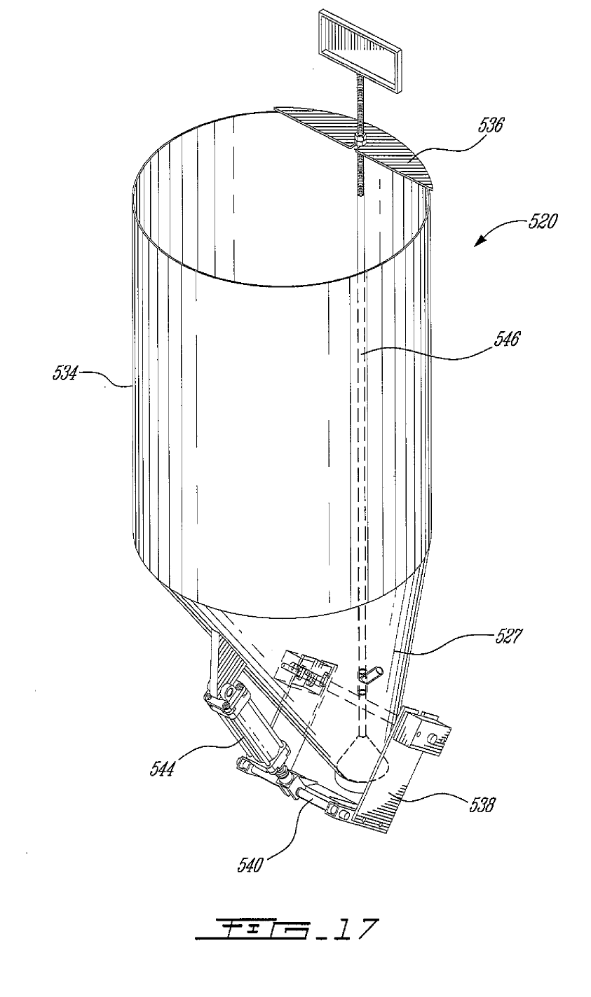

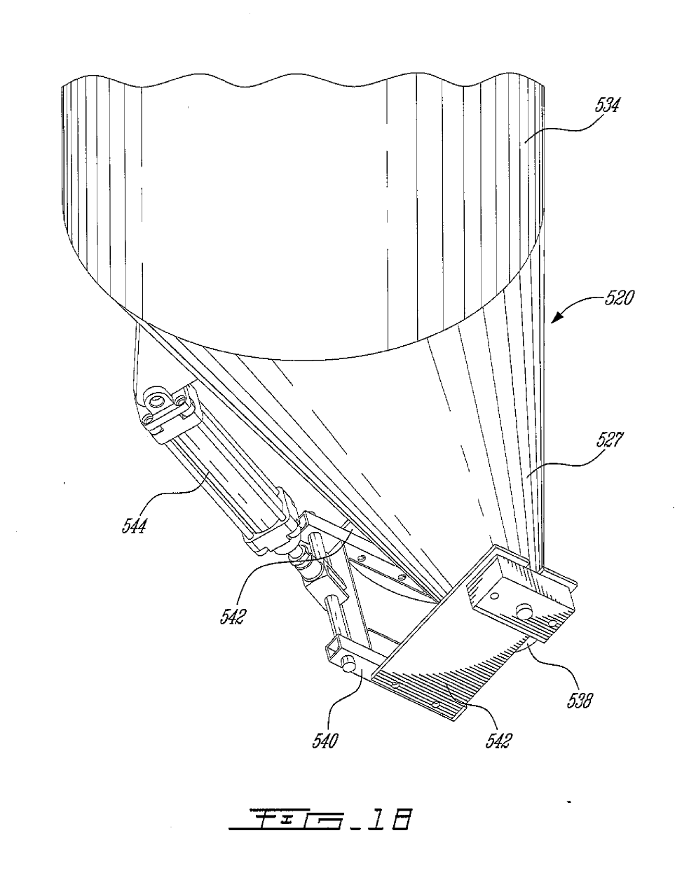

With reference to FIGS. 17 and 18, vats 520 and 522 (only vat 520 is illustrated here) comprise a top feed hopper body 534 having a top opening 536 at it top end and nozzle 524 at its opposite end which terminates with a bottom opening 538 for releasing concrete therethrough. A moveable trap 540 is pivotally mounted to nozzle 524 via panels 542 so as to close and open the concrete release thereby respectively enclosing concrete thus stopping the pouring operation as show in FIG. 17 or releasing concrete for pouring thereof into a mold compartment 20 as shown in the position of FIG. 18. The trap 540 is actuated by a two stroke cylinder 544 mounted thereto and to nozzle 527 and providing to open the trap between two pouring operations: an initial discharge which provides for quickly filling the mold 14 and a second discharge which provides for refining filling of mold 14. Each vat 520 and 522 contains a mechanical system 546 that provides for slowing down the speed of pouring and to provide a continuous reading of the remaining concrete mixture within the vat 520 or 522. These mechanical systems 546 are adjustable and removable. Concurrently during the pouring operation, the vats 520 and 522 receiving a concrete mixture from the batching station 900 as will be described herein.

With reference to FIG. 2, 3, 4 and 19, the leveling station 600 will now be described. The now filled mold 14 will be moved along conveyor tracks 514 and 516 as shown by arrow IV onto the leveling station 600. The mold 14 is positioned on a platform 602 via a locating stopper 604 that is actuated by a hydraulic cylinder 606 to either be raised causing the displaced mold 14 to abut the stopper 644 or to be withdrawn from the pathway of the mold 14. Once the mold 14 is positioned on platform 602, the platform 602 is raised along vertical arrow L via actuators 608 such as hydraulic means and the like above conveyor tracks 514 and 516; the actuators 608 then cause the platform 602 along with the mold 14 and its contents to vibrate. This vibrating operation levels the concrete within compartments 20, removing air bubbles for example, as well as leveling the concrete and homogenizing the mixture. Once the vibrating operation is complete, the platform 606 is lowered along arrow L so as to lay the mold 14 on the conveying tracks 514 and 516 which displace the mold 14 towards the stacking station 700 as shown by arrow V.

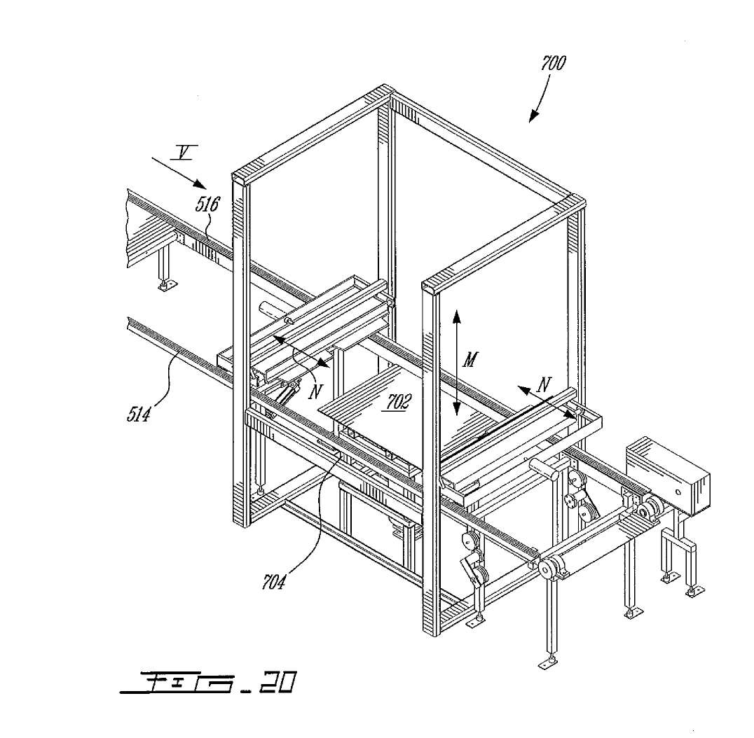

With reference to FIG. 20 the stacking station 700 will be described. Each leveled and filled mold 14 is brought, one at a time, to the stacking station 700 via conveyor tracks 514 and 516. The stacking station 700 forms a pile that has predetermined by the operator. This operation resembles that of the unstacking station 200 previously described. More particularly, a mold 14 is displaced above an elevation platform 702 which is moveable along a vertical arrow M via actuators 704. As the mold 14 is positioned above platform 702 (this can be determined by an electronic reader for example), platform 702 moves upwardly engaging and then raising the mold 14 at a predetermined distance above tracks 514 and 516 between a pair of jaws 704, which are reciprocally moveable along arrows N between proximal and distal positions. As the platform 702 raises the mold 14 between jaws 704, the jaws 704 withdraw towards their distal position clearing a space therebetween for the rising mold 14. Once the predetermined height is achieved, the jaws 704 are moved toward their proximal position, the platform 702 is lowered through the space defined by the mold-engaging protrusions 706 of the jaws 704 lowering the mold 14 onto these mold-engaging protrusions 706. The platform 702 is then available to receive a subsequent mold 14. As this subsequent mold 14 is displaced along tracks 514 and 516 beneath the jaws 704 and a previously stacked mold 14 and directly above platform 702, the platform 702 rises engaging this subsequent mold 14 and raising it causing it to engage the previous mold 14. At this point the jaws 704 withdraw, allowing the previous mold to rest on the subsequent mold. The platform 704 will hence raise both molds. When the subsequent mold 14 is at the predetermined distance then the platform 704 is lowered allowing for subsequent mold 14 which now carries the previous mold to rest on the mold-engaging protrusions 706 of the jaws 704 which have been moved towards their proximal position. This operation is repeated until a desired amount of molds 14 has been stacked. The stack may then be removed from station 700 at which point a new stack can be formed

The stacked molds can be removed and brought to the curing station 800 via a forklift, conveyor or other such transportation means.

Curing Station

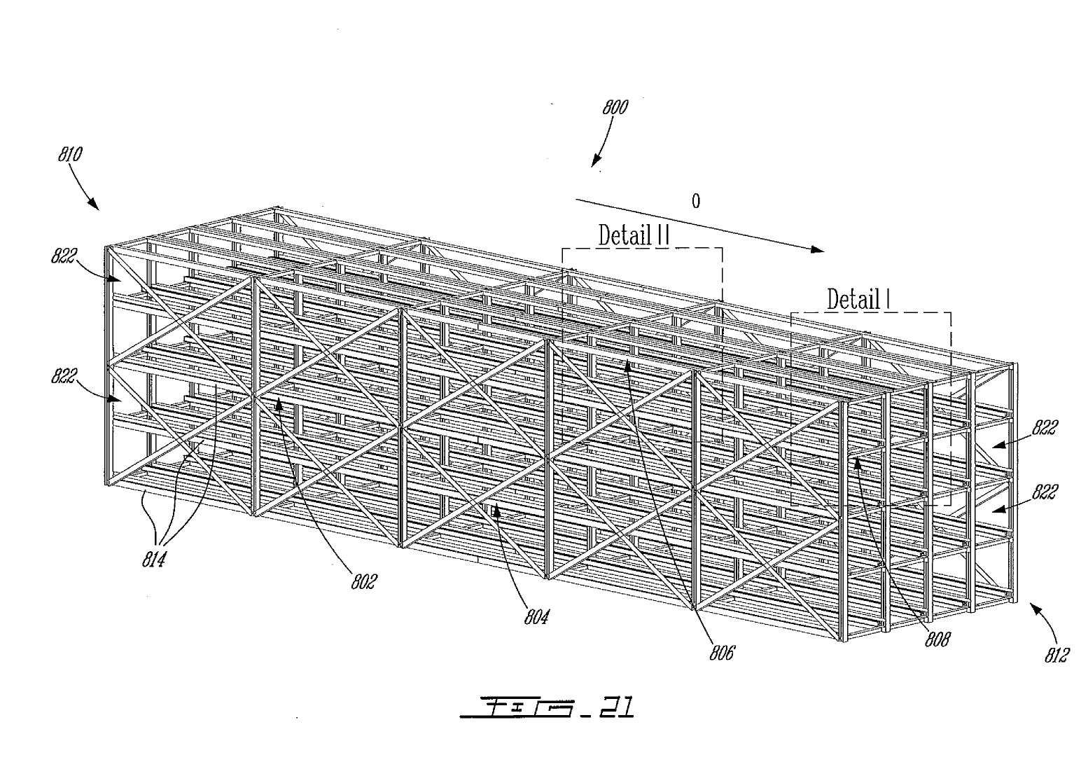

With reference to FIGS. 21, 22, 23 and 24 the curing station 800 will now be described.

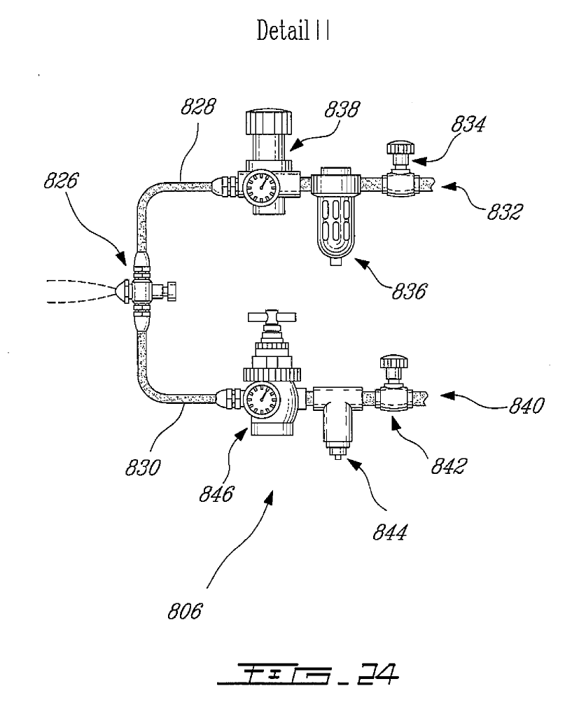

FIG. 21 illustrates the curing station 800 comprising support structure 802 with external shell 804 that is leak proof and resistant to humidity defining a curing chamber, a system 806 for controlling and maintaining humidity (Detail II) which comprises a plurality of nozzles 826 (see FIG. 24) installed on the periphery of the support structure, and equipment 808 for stocking and handling the stacks of molds 14 (Detail I).

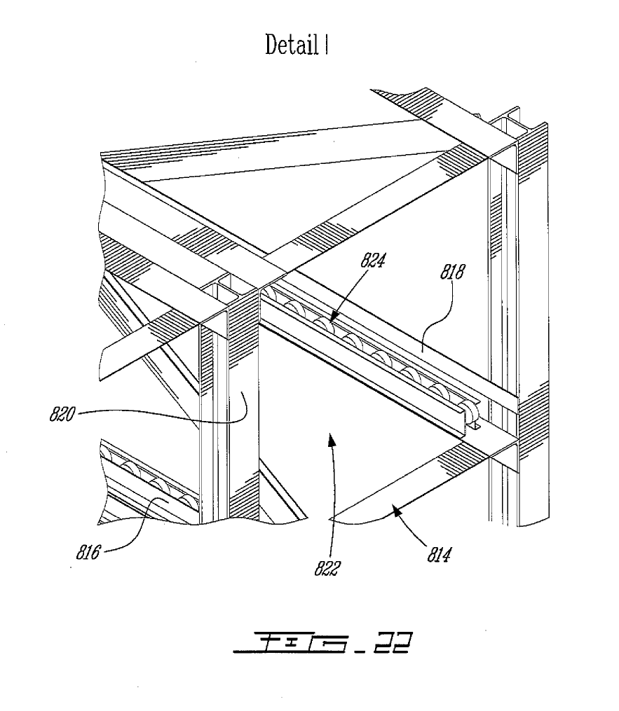

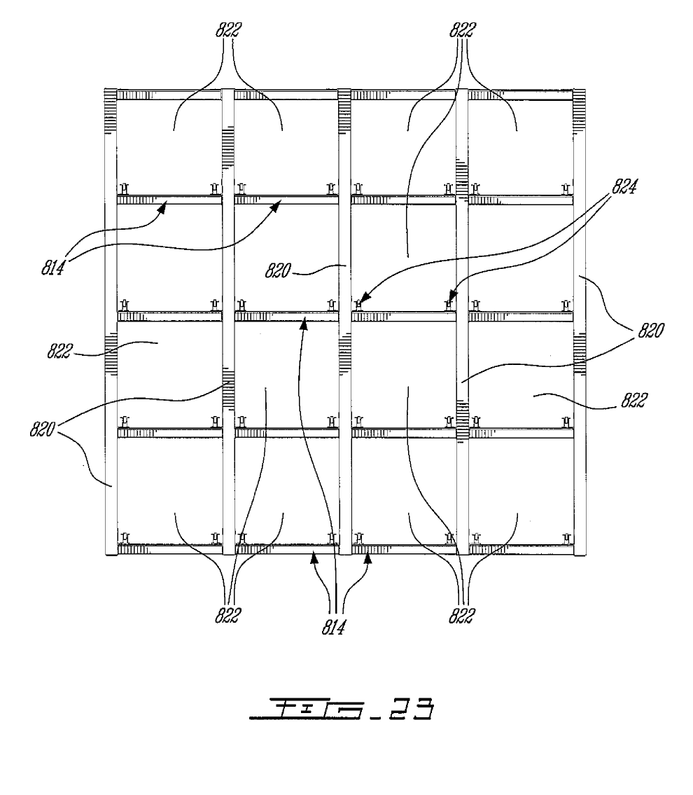

The stocking and handling equipment 808 will now be described. The support structure 802 comprises an entry end 810 for receiving stacks of molds and an opposite exit end 812 so that the stacks of molds 14 can be removed. The support structure 802 comprises a plurality of levels or floors 814 defined by opposite rails 816 and 818 (see FIGS. 22 and 23). Each floor 814 is separated into adjacent portions via vertical members 820 thereby defining a plurality of longitudinal tunnels 822. The support structure 802 is downwardly slanted from its entry end 812 to its exit end 814. Rollers 824 are provide along the downwardly slanted rails 816 and 818 thereby providing for the stacks of molds within each tunnel 822 to be displaced along these rollers 824 as shown by arrow O by gravity pull. The products 12 remain with the curing chamber for a predetermined time frame in order to ensure optimal curing which provides for maximizing the aesthetic and mechanical properties of the product. The support structure 802 is modular so as to allow for additional or less tunnels 822.

With respect to FIG. 24, the system 806 for controlling and maintaining humidity will now be described. System 806 comprises a plurality of pulverization nozzles 826. A nozzle 826 is in communication with tow opposite conduits 828 and 830 respectively. Conduit 828 includes an opening 832 and a valve 834, upstream the opening 832, for arresting or allowing air entry. The air which has entered conduit 828 will be filtered via an air filter 836, and the filtered air is then pressurized as it streams through an air-pressure regulator 838 to be finally led towards the nozzle 826. Concurrently, conduit 830 includes a water entry opening 842 for receiving water therein, a valve 844 is positioned upstream this opening 842 for arresting or allowing water entry. The entered water streams through a water filter 844, the filtered water then passes through a liquid-pressure regulator for pressure regulation thereof to be finally led towards the nozzle 826 where it will meet with the filtered and pressurized air. Humidity sensors (not shown) are used to read the percentage of humidity and to conserve humidity at a predetermined level. Accordingly, when the level of humidity falls below the pre-programmed threshold, the pulverizing or vaporizing nozzles 826 release fine drops of water to raise the level of humidity.

Once the curing process is complete, the stacks of molds 14 with products 12 are transported to the unstacking station 200.

Concrete Batching Station

As mentioned above and with reference to FIGS. 1 and 2 the concrete batching station 900 mixes and prepares molding mixtures to be transported to the concrete pouring station 500.

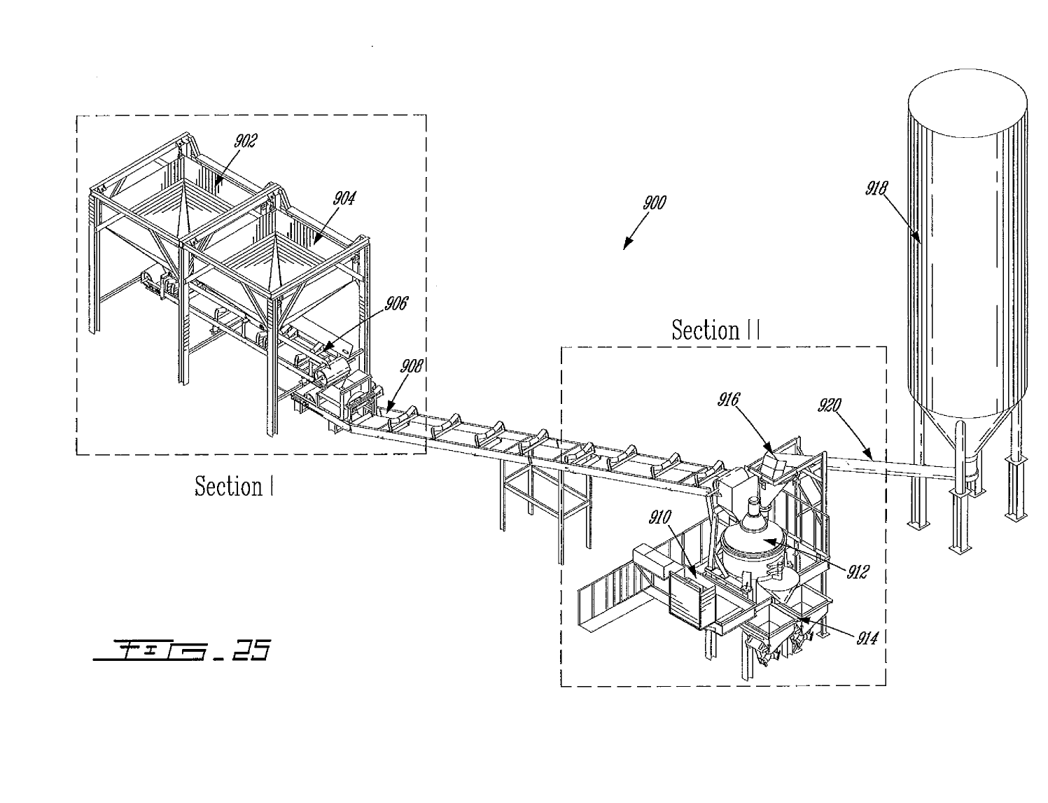

With reference to FIGS. 25, 26, 27, 28, 29, 30, 31 and 32 the batching station will now be described.

FIG. 25 shows the batching station illustratively comprising: a weighing and storage bin 902 for Aggregate A; a weighing and storage bin 904 for Aggregate B; aggregate-weighing handling and control equipment 906; aggregate handling equipment 908; adjuvant dosing and injecting system 910; concrete mixing station 912; handling equipment 914 for concrete towards the pouring station 500; concrete weighing and accumulating bin 916; cement storage silo 918; and cement handling equipment 920.

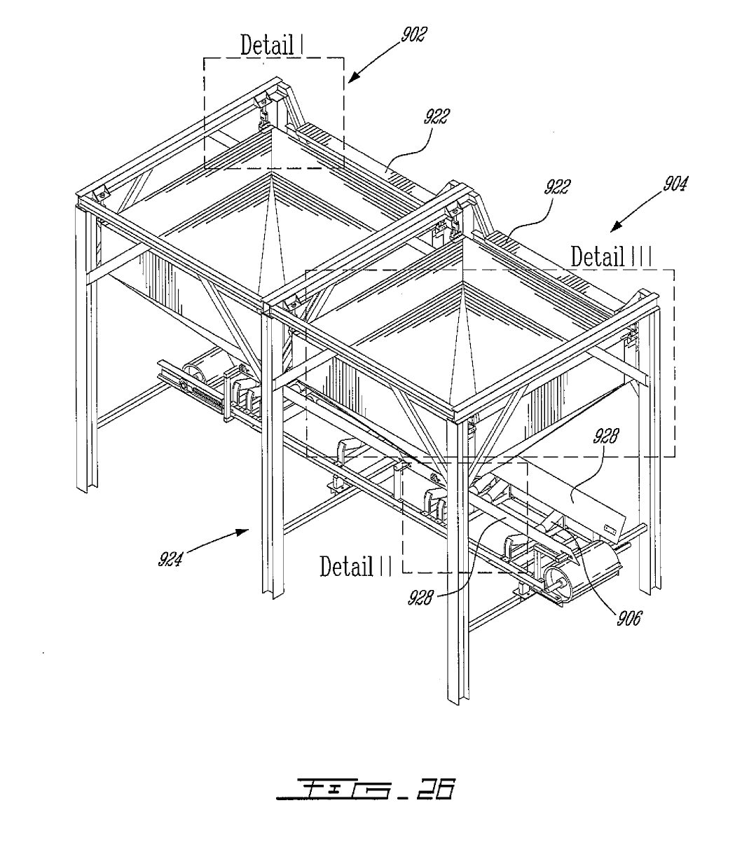

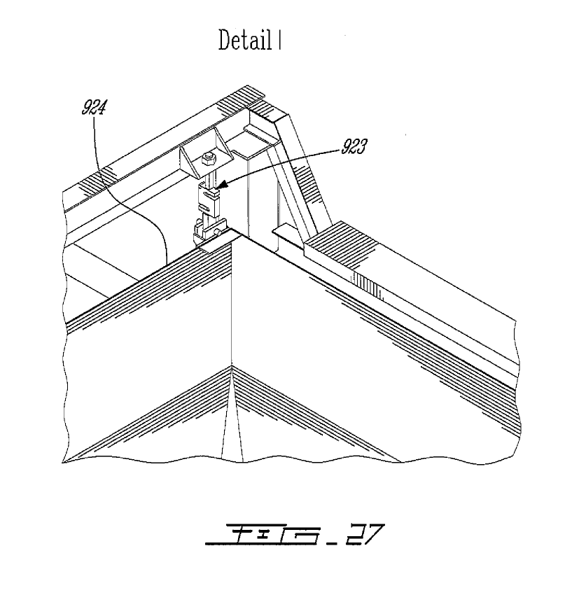

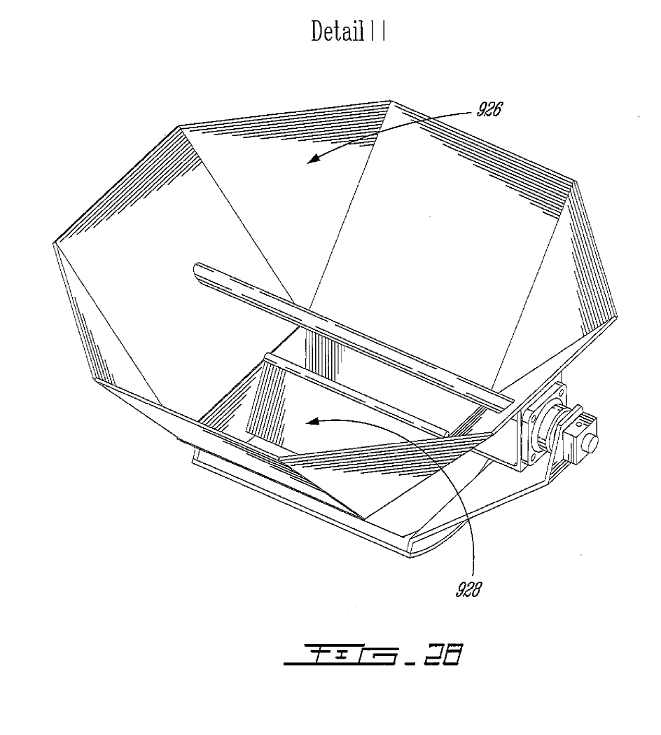

With reference to FIG. 26, the aggregate weighing and storage bins 902 and 904 are hoisted on respective load cells 922 mounted to a support structure 924. The load cells 922 are responsible for reading the internal weight of bins 902 and 904. During the beginning of a desired concrete mixture recipe, pneumatic gates 926 (see FIG. 28-30) are open so as to allow a predetermined quantity of aggregate weight to fall on the aggregate-weighing handling and control equipment 906 before the gates 926 close. The load cells 922 then verify the weight of bins 902 and 904 in order to compare it to their initial weight, i.e. the weight before the gates 926 were opened. This operation is performed in order to obtain the weight differential before the opening of the gates and after their subsequent closing. The differential weight value obtained is equal to the weight that fell on the aggregate-weighing handling and control equipment 906. This operation is repeated until the weight necessary for that desired concrete mixture recipe is obtained. This operation is performed simultaneously for bins 902 and 904. When the type of aggregate that is used permits water absorption and as such modifies the density and therefore the weight for the same volume occupying a given space, a moisture sensor can be incorporated into the system in order to effectuate compensation that is proportional to the water detected in the aggregate (i.e. to signal the system to provide for extra aggregate in order to return the internal content of the bin to its initial density). With reference to FIG. 27, the load cells 922 constitute the only link between the bins 902 and 904 and the support structure 924 and as such provide for weighing the aggregates. Furthermore, the load cells 922 by way of their mounting links 923, provide the bins 902 and 904 to be freely movable along the horizontal plane thereof. The foregoing providing a more precise and exact reading in real time of the internal contents of bins 902 and 904 without being affected by the lateral and longitudinal forces acting on bins 902 and 904.

With respect to FIG. 28, the pneumatic gates 926 which are situated at the bottom of bins 902 and 904 have a generally octagonal configuration, which eliminates sharp stops in corners and as such avoids the accumulation of obstructive material. Deflectors 928 are positioned beneath the gates 926 in order to avoid that the weight of the aggregates is applied on the aggregate-weighing handling and control equipment 906 which will falsify weight measurement.

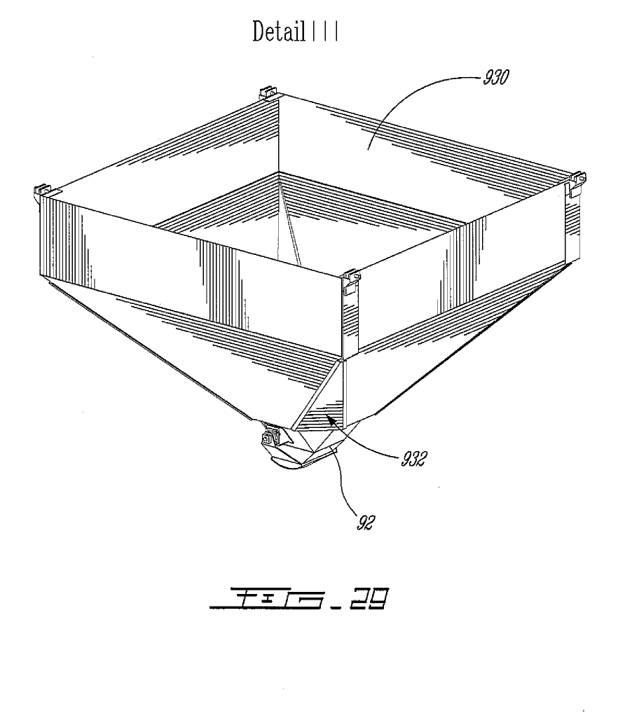

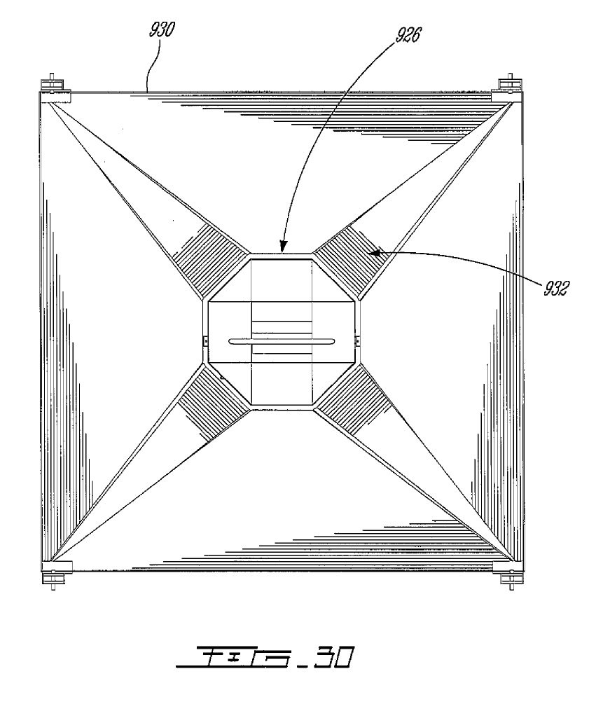

With reference to FIGS. 29 and 30, the bins 902 and 904 (only bin 904 is illustrated here) comprise a top portion 930 having a square configuration that is turned into an octagonal configuration via side portions 932.

Simultaneously with the above weighing operation, the aggregate handling equipment 908 sequentially transports the weighed quantities of aggregate towards the concrete mixing station 912.

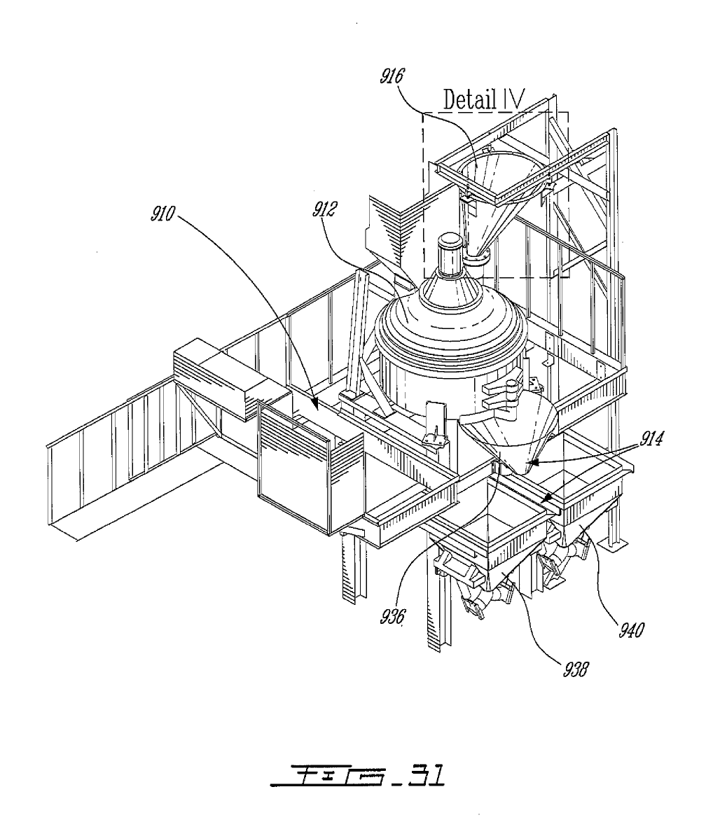

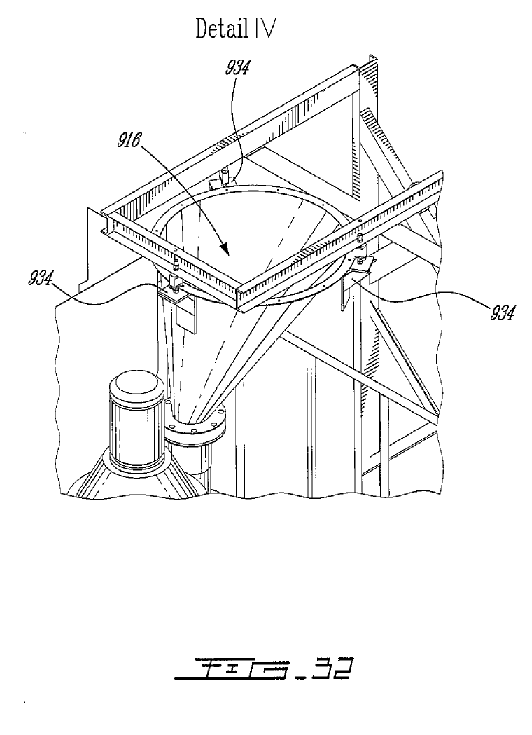

Concurrently, the cement handling equipment 920 transports the cement from the cement storage silo 918 towards the concrete weighing and accumulating bin 916. With reference to FIGS. 31 and 32, bin 916 is suspended by load cells 934, similarly to bins 902 and 904, which are responsible for measuring the weight of the internal contents of bin 916. As for bins 902 and 904, the bottom of bin 916 comprises pneumatic gates (not shown). The cement handling equipment 920 transports cement to bin 916 until a predetermined weight of cement necessary for a given mixture is obtained. Aggregates A and B as well as the cement are all incorporated in the concrete mixing station 912 where they are uniformly mixed for a predetermined period of time that is necessary for that given mixture recipe. During this mixing process, the adjuvant dosing and injecting system 910 prepares the necessary quantities of each adjuvant respecting a precise sequence. This adjuvant mixture is then injected in the concrete mixing station 912 via diaphragm pumps. The obtained concrete is then discharged via funnel 936 into bins 938 and 940 for transporting this concrete mixture to the pouring station 500.

The software of the GRB concrete pre mixing is a software that allows for managing and visualizing the production of a mixture in order to produce cement rocks. For being capable of producing with the batching software, there are a few configurations that must initially be effectuated. We must first create ingredients, indicate in which silo or in which pump there are found and finally create recipes. Furthermore, before starting production, there are a few supplementary parameters that we have to configure in the Parameter table.

Creation of Ingredients:

In order to have access to the ingredient creation menu, we must first click on the recipe tab and then on Ingredients.

[image]

When we create an ingredient, the two first parameters that must be configured are the name and the number of this ingredient. Then, we must indicate if the ingredient is a solid type or liquid. Should be noted that, if the liquid option is selected, we must enter the weight in grams for one ml. This is useful for inventory during the reception of ingredients. Purchase of most ingredients, even liquid ones, is mostly by weight. The other available options are the Lo Hi limit. They define the accepted tolerance during the application of this ingredient. If, for example, we want to apply 100 ml of adjuvant number 1, we can tolerate a result of 97 ml, which corresponds to 3 ml under the requested value (Lo limit). Nevertheless, if the applied value passed 105 ml (Hi limit), the system will generate an alarm. The next parameter corresponds to the quantity of this ingredient in the inventory of the system. Finally, the last parameters that should be configured for an ingredient are the Substitute ingredients. The Substitute ingredients are products that can replace the current ingredient.

Silo Assignment:

In order to access the assignment menu, we must click on the silo tab. The menu that will appear is illustrated herein below:

[image]

What is meant by assignment is the tracking of the ingredients through the different silos (solid ingredients or basins (liquid ingredient)). This assignment is necessary since the system will refuse to execute a recipe that contains an ingredient that is not associated with any silo or basin. To assign an ingredient, one must click on the “Assigner” button and then on rectangle number. “du silo” or “du basin assigné”. The list of available ingredients will appear and then the user may click on the desired ingredient. For each assignment, its free fall must be defined. What is meant by Free Fall is the quality which correspond to the reactions time at the moment where we close the trap or pump and the quantity which continues to pour. If we take for example sand, the free fall corresponds to the quantity that is found between the trap and the conveyer. To find this value without reducing the cement product quality, it is advisable to adjust the value to a high integer, for example 30 kg for sand and to progressively reduce it as we produce. If the free fall value is too high the trap will close too early and there will be a variation between the requested quantity and the quantity received. The system will fall in Jog mode. In this mode, we open the trap for a short moment and verify if the quantity was reach. If this is not the case, then we must start again. A free fall that is properly adjusted should not need more than two sequences in Jog mode.

Creation of Recipes:

To create a recipe, one must click on the recipe tab and then on “Ajouter”. The name of the recipe must be entered and then the user has the possibility to enter a note in order to facilitate tracking. Should be noted that the number of the recipe is the number automatically associated, however, this number can be changed by the operator. Once the recipe has been created, the user must click on ingredient of the recipe in order to see the details thereof. Herein below is the menu that will appear:

[image]

In order to add an ingredient, one must click on the ingredient rectangle. The list of all the available ingredients will appear and one that is desired can be selected. In order to enter the quantity desired, the user must click on the rectangle “Quantité” and enter the number via the keyboard. Should be noted that the measurement unit of the ingredients depends if the ingredients are either solid or liquid (see section creation of ingredients). The total amount of solid and liquid ingredients will appear at the bottom of the page.

Parameter of the System:

In this menu we adjust the speed of the conveyers and the configuration relating to the moisture (humidity sensor).

[image]

Conveyer:

With regards to the speed of the conveyers, the only restriction is that the speed of an inclined conveyer cannot be faster that the speed of a horizontal conveyer. However, it is advised to not adjust the speed too high in order to allow for the sand to pour in a constant fashion on the conveyer.

Humidity:

There is a moisture or humidity sensor installed in the silo of sand that informs us of the level of humidity therein. When the sand used is very moist, it needs less water during its mixture. Therefore, in this menu, the quantity of water that is to be subtracted in the recipe depends on the humidity level. In order to accomplish this, we configure the minimum water value to remove for certain percentage as well as the maximum quantity. With these parameters, we are able to establish a graph for measuring humidity between minimum and maximum percentages.

Production Schedule:

In order to access the production schedule menu, select the fabrication tab and press on “Cédule”.

[image]

In this menu we can add a production batch, modify or delete a batch already created. When we create a batch we must first associate a number to it. This number is automatically generated by the system. We can enter a description and also associate it to a client. We must then select the recipe we wish to execute as well as the number of desired batches. Once a production batch is created, it will appear in the list on the left image and at all time we can change the order of execution of the batches by pressing on the arrow which is at the right of the page. It is important to know that the system execute from the top to bottom the batches which appear on the list. Furthermore, if the system is functioning, we cannot change the order of a batch that is running. In order to start or shut down a schedule we must press on the first button at the top left. It should be noted that if the system is in stop mode this button is called “Démarrer” (start) and if it is running is called “Arrêeter” (shut down).

Fabrication Menu:

This menu informs us of the state of equipment and of production. Herein below is the information that we find:

[image]

1: This header appears no matter what menu we happen to be in. It informs us first of the batch as well as the recipe that is presently executed. If the information that is posted in green that means that the batch is running, if they are posted in yellow, this means that the batch is running but waiting for confirmation to start (the operator confirms the starting by pressing on the button near the mixer). Finally, if the information posted is in blue that indicates that the system has stopped. Furthermore, in this header, we see the state of the mixer. “Hors Fonction” indicated that the mixer has stopped, “En Fonction” posted in green indicates that the mixer has started and finally “En Fonction” posted in yellow indicates that the mixer is full and in the process of mixing.

2: On this table, we can see the ingredients of the recipe in process as well as the requested value for each ingredient. Furthermore, as we progressively apply the ingredients we can see in real time the real quantity that is applied for each ingredient.

3: The weight of each vat is posted. We can also see the state of each trap in the way of an animation that clearly indicates if the trap is opened.

4: Concerning the state of the conveyers, it appears in green when they are functioning. Furthermore, if any one of them would signal an alarm, this information is transmitted by posting a red X on the conveyer that is faulty.

5: For the mixer section two data are transmitted; the state of the mixing motor as well as the position of the exit trap. In both cases, blue indicates that they are not functioning and green indicates that they are functioning. Furthermore, if ever either one of them would signal an alarm this data is transmitted by posting a red X on the one that is in default.

6: “Section des liquids” (Liquid section) In this section we can see the adjuvant associated to each pump and the valve as well as the state thereof. In every case, blue indicates that they are not functioning and green indicates that they are functioning. Furthermore, if either of them signals an alarm, this data is transmitted by posting a red X on the faulty device.

7: “Le silo à ciment” (cement silo) We can know the quantity of cement present in the silo. Contrary to the vat, this information is not transmitted by the use of load cells. When the administrator receives a command for cement he must indicates the quantity of cement received by pressing on the “Reception” button and then as we progressively use cement in the production, we will subtract the total quantity present in the silo.

The “Bavard” Menu:

In order to have access to the menu, we must access the “Bavards” tab. This menu is used essentially in order to have data on the batches that have already been effectuated in the past.

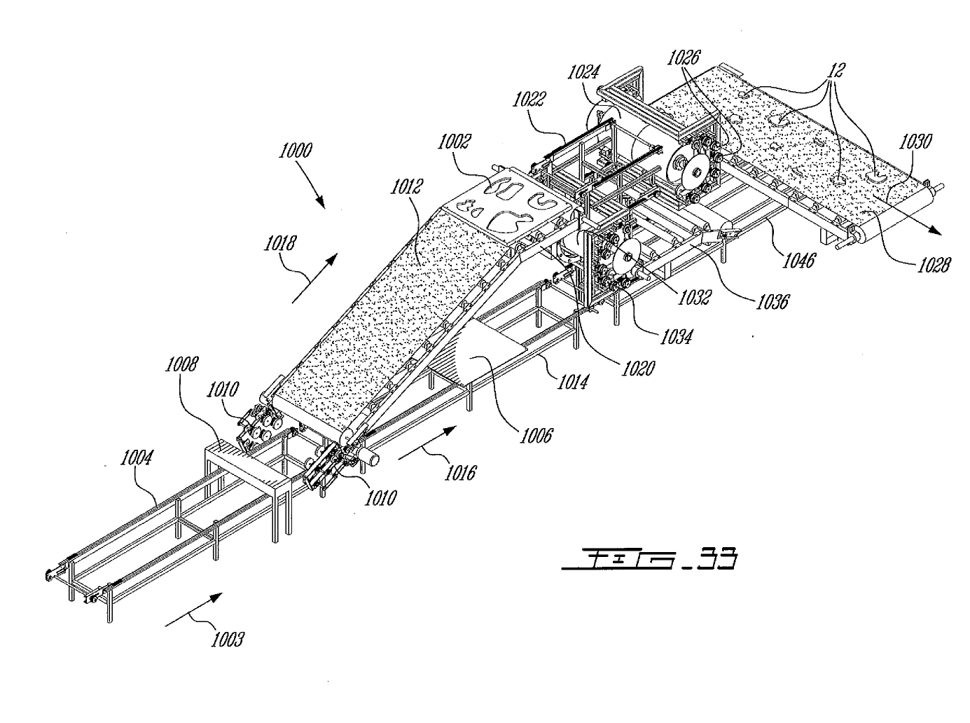

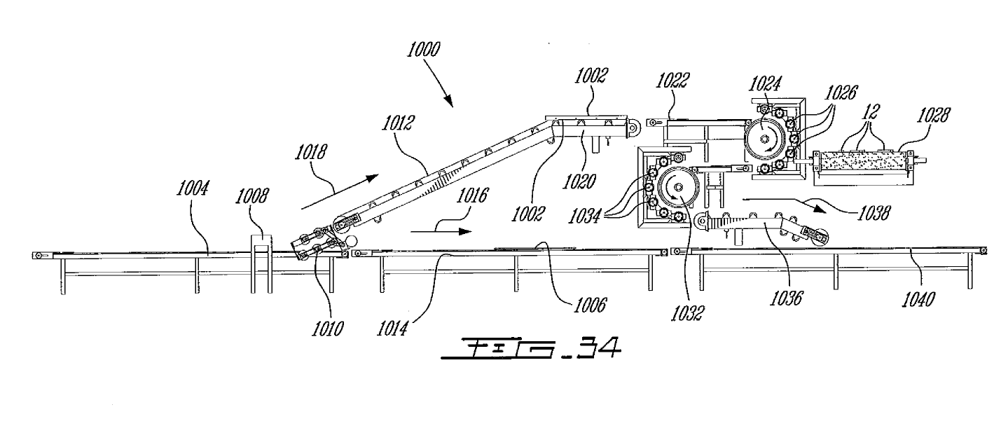

Now turning to FIGS. 33 and 34, there is herein shown a variant unmolding station 1000 for use with a flexible mold 1002, which is made for example of polyurethane. The flexible mold 1002, when it is displaced along arrow 1003 by incoming conveyor 1004, is supported onto a rigid plate 1006 (for instance, made of steel). The flexible mold 1002 is wider than the plate 1006 such that its lateral edges (i.e. those parallel to the direction of the incoming conveyor 1004) extend outwardly of the rigid plate 1006. The flexible mold 1002 passes under a reader unit 1008 that identifies the mold 1002, for instance so as to convey it to the proper station(s) or other.

After having passed the reader unit 1008, the mold 1002 is grippingly picked up at its lateral edges by a pair of 5-wheeled traction units 1010 provided on each side of the incoming conveyor 1004, thereby separating the flexible mold 1002 from the rigid plate 1006. The mold 1002 is thus brought onto an angled upper conveyor 1012 by the traction units 1010, whereas the rigid plate 1006 is brought onto a lower conveyor 1014 (as seen in FIG. 33) along arrow 1016. The mold 1002 is displaced along arrow 1018 along the upper conveyor 1012 until it reaches an upper horizontal section 1020 of the upper conveyor 1012 (in FIG. 33, the mold 1002 is shown on this upper horizontal section 1020).

The mold 1002 is then brought onto a short conveyor 1022 and towards an ejection roll 1024. The mold 1002 is then engaged around the ejection roll 1024, being guidingly held by support rollers 1026, both the ejection roll 1024 and the support rollers 1026 being herein motorized. The deformation of the flexible mold 1002 from its original flat position to an arcuate position around the ejection roll 1024 forces the molded products 12 out of the mold 1002 and onto a molded product conveyor 1028 that conveys the molded products 12 along arrow 1030, typically to a packaging-type station.

The mold 1002 is then turned back to its original position (i.e. with its cavity-side up) by a second roll 1032 and associated rollers 1034. The mold 1002 is then brought by an elbowed conveyor 1036 along arrow 1038 and onto an output conveyor 1040, whereat the mold 1002 is deposited back atop the rigid plate 1006 that has been brought onto the output conveyor 1040 by the lower conveyor 1014. The empty mold 1002 and the underlying rigid plate 1006 are then conveyed, for instance, to a mold-filling station.

Although the invention has been described with reference to certain specific embodiments, various modifications thereof will be apparent to those skilled in the art without departing from the spirit and scope of the invention as outlined in the claims appended hereto.

1. A system for producing cementitious products, said system comprising:
at least one mold for receiving cementitious material therein;
a molding and an unmolding subsystem comprising:
a pouring station for pouring the cementitious material into said mold;
a demolding station for removing formed cementitious products after curing thereof from said mold; and
a movement imparting system for imparting a translational movement between said mold and said molding and an unmolding subsystem.

2. A system according to claim 1, wherein said molding and an unmolding subsystem further comprises:
a mold pre-processing station positioned between said demolding station and said pouring station for treating said mold after removal of the formed cementitious products so as to be in condition for receiving the cementitious material

3. A system according to claim 1, wherein said molding and an unmolding subsystem further comprises:
a stacking station upstream said demolding station for stacking a plurality of mold containing poured cementitious material.

4. A system according to claim 3, wherein said molding and an unmolding subsystem further comprises:
an unstacking station for upstream said stacking station and for unstacking said plurality of mold containing formed cementitious products after curing thereof, said unstacking station being downstream said demolding station.

5. A system according to claim 3, wherein said molding and an unmolding subsystem further comprises a leveling station positioned between said pouring station and said stacking station so as to level the poured cementitious material in said mold before stacking thereof.

6. A system according to claim 1, wherein said demolding station comprises:
an unmolding system for dislodging and extracting the cementitious products from said mold; and
a stacking system for storing the extracted products.

7. A system according to claim 1 further comprising, a curing station.

8. A system according to claim 1 further comprising, batching station for preparing a cementitious material mixture for said pouring station.

9. A demolding station for dislodging and removing molded cementitious products from a mold, said demolding station comprising a dislodging system, said mold comprising a bottom plate portion and top resilient portion containing the molded cementitious products, said bottom plate portion comprising openings, said dislodging system comprising moveable protrusions for engaging said top resilient portion through said bottom portion openings thereby dislodging said cementitious products.

10. A demolding station according to claim 9 further comprising a retaining member for retaining a periphery of said mold top resilient portion during said dislodging operation.

11. A demolding station according to claim 9, further comprising a suction-device positioned above said mold so as to apply a suction force on said cementitious products during said dislodging operation.

12. A demolding station according to claim 9 further comprising, a suction-device positioned above said mold for removing said cementitious products after said dislodging operation.

13. A demolding station according to claim 12, wherein said suction-device is moveable so as to transfer said removed cementitious products towards a stacking system.

14. A pouring station for pouring cementitious material into a mold for molding a cementitious product, said mold comprising at least one mold compartment, said station comprising:
a cementitious material pouring device,
a movement imparting device for imparting a translational movement between said pouring device and said mold, and
a locating device for stopping said mold during translational movement thereof at least one predetermined position, said predetermined position corresponding to a predetermined position of said at least one mold compartment near said pouring device so as to receive cementitious material therefrom;
wherein when said locating device stops said mold at said predetermined position said pouring device pours cementitious material in said predeterminedly positioned mold compartment.

15. A pouring station according to claim 14, wherein said mold comprises a plurality of compartments.

16. A pouring station according to claim 14, wherein said cementitious pouring device comprises at least one vat.

17. A pouring station according to claim 16, wherein said vat comprises a bottom nozzle comprising an opening, a removable trap being positioned about said opening.

18. A pouring station according to claim 14, wherein said movement imparting device comprises a conveyor.

19. A pouring station according to claim 14, wherein said locating device comprises a plurality of retractable stoppers.

20. A curing station for curing cementitious material within molds, said station comprising support structure defining a curing chamber, said support structure defining a mold entry end and an opposite mold exit end and having a downward inclination from said entry end to said exit end for providing for said molds in said curing chamber to be displaced via gravity pull from said entry end to said exit end, wherein said period of time for displacing said molds from said entry end to said displacement end is sufficient for curing the cementitious material within said molds.

21. A curing station according to claim 20, wherein said support structure comprises rollers for providing said molds to be displaced thereon.

22. A curing station according to claim 20, wherein said support structure comprises a plurality of levels defined by rails separated by longitudinal members thereby defining tunnels, each said tunnel configured to receive a stack of said molds.

23. A curing station according to claim 20, wherein said support structure comprises a system for maintaining and controlling humidity within said curing chamber.

24. A batching station for preparing molding mixtures of cementitious material, said station comprising:
concrete mixing station;
weighing and storage bins for aggregates;
aggregate-weighing handling and control equipment positioned beneath said bins and in communication with said concrete mixing station;
aggregate handling equipment in communication with said aggregate-weighing handling and control equipment;
adjuvant dosing and injecting system in communication with said concrete mixing station;
cement storage silo;
cement handling equipment in communication with said cement storage silo; and
concrete weighing and accumulating bin in communication with said cement handling equipment and said concrete mixing station

25. A system for producing cementitious products, said system comprising a controller linked to a molding and an unmolding subsystem; and a batching station for receiving data therefrom and signaling data thereto.

26. A method for producing cementitious products, said method comprising:
providing a plurality molds;
displacing said plurality of molds on a continuous pathway during said method successively pouring cementitious material into said molds;
continuously batching a mixture of cementitious material mixture that is to be poured leveling said poured cementitious material within said molds;
stacking said molds with said leveled cementitious material;
providing a curing chamber for allowing displacement of said stacks of mold therein from an entry end to an exit end thereof for a sufficient curing time to provide formed cementitious products;
unstacking said stacked molds having said formed cementitious products;
dislodging said formed cementitious products from said molds;
removing said formed cementitious products from said molds;
stacking said cementitious products; and
treating said emptied molds so as to render said molds in condition to receive cementitious material.
